(19) United States
(12) Patent Application Publication
(10) Pub. No.: US 2025/0137842 A1
(43) Pub. Date: May 1, 2025

(54) SENSOR MODULE, MANUFACTURING METHOD THEREFOR, AND SENSOR SYSTEM

(71) Applicant: NIPPON CHEMI-CON CORPORATION, Tokyo (JP)

(72) Inventors: Katsuya Tamaki, Tokyo (JP); Ikufumi Honda, Tokyo (JP); Naohisa Shibata, Tokyo (JP)

(73) Assignee: NIPPON CHEMI-CON CORPORATION, Tokyo (JP)

(21) Appl. No.: 18/730,559

(22) PCT Filed: Mar. 16, 2023
(86) PCT No.: PCT/JP2023/010260

§ 371 Date: Jul. 19, 2024

(30) Foreign Application Priority Data
Mar. 24, 2022 (JP) 2022-048106

(51) Int. Cl. G01J 1/04

(52) U.S. Cl. CPC G01J 1/0403; G01J 1/0411

(57) ABSTRACT

An alignment property between a mount portion to which a lens unit is mounted and the lens unit is eliminated, and the degree of freedom in selecting and designing the lens unit and the mount portion is increased by an alignment function of an attachment portion. A sensor module of the present disclosure includes a lens unit, a base portion on which a sensor for receiving light from the lens unit is installed, a mount portion installed on the base portion, and an attachment portion that aligns the mount portion with the lens unit.

### TECHNICAL FIELD

The present disclosure relates to, for example, a sensor technology used for detecting reflected light, an image, and the like from a subject.

### BACKGROUND ART

In a sensor module for detecting reflected light, an image, and the like from a subject, a lens unit is mounted by installing a mount portion on a base portion where a sensor is installed. The lens unit is selected depending on an application, an intended function, and the like, but its outer diameter varies. Therefore, the mount portion needs to be aligned with the lens unit to be used.

Regarding the mounting of such a lens unit, it is disclosed that, in a case where a lens having a small outer diameter is mounted on a lens mount portion, an adapter corresponding to a lens having a large outer diameter is prepared, and a male screw and a female screw are formed on the adapter so that different lenses can be mounted (for example, Patent Literature 1). This is merely mounting the different-diameter lens by using the adapter.

### CITATION LIST

### Patent Literature

Patent Literature 1: JP 2006-276420 A

### SUMMARY OF INVENTION

### Technical Problem

The sensor module includes the base portion, an optical filter, and an image sensor, and is used for a distance meter, a camera, and the like. In this sensor module, in addition to a lens unit having a different outer diameter for an application or a purpose, an optical filter having a suitable specification is required. That is, even in a case where a specific sensor is used, when a different lens unit or optical filter is used, a different function can be obtained depending on the optical characteristics. Even when the lens unit is made common, a different function can be obtained by a different optical filter.

Therefore, when the lens unit is selected to realize a desired function, the mount portion for mounting the lens unit needs to be aligned with the lens unit. That is, the mount portion corresponding to the outer diameter of the lens unit is required. Therefore, in order to align the lens unit with the mount portion, when a specific lens unit is selected, a mount portion corresponding thereto is required. That is, when the mount portion aligned with the lens unit is specified, there are problems that another lens unit having a different outer diameter cannot be attached and that a lens unit having a different diameter cannot be freely aligned with the mount portion for the specific lens unit.

When the optical filter is installed in the lens unit according to the purpose, it is effective in that different optical characteristics can be obtained for each lens unit. However, it is not easy to individually realize the lens units including different optical filters, and there is a problem that an increase in variation of the optical filters increases cost.

The inventors of the present disclosure have found that it is effective to eliminate a mechanical alignment property between the lens unit and the mount portion, to increase the degree of freedom in selecting the lens unit, and to enable setting of a function according to an application separately from the lens unit.

Therefore, in view of the above problems and the above findings, an object of the present disclosure is to eliminate an alignment property between a mount portion to which a lens unit is mounted and the lens unit, and to increase the degree of freedom in selecting and designing the lens unit and the mount portion by an alignment function of an attachment portion.

In addition, in view of the above problems and the above findings, another object of the present disclosure is to enable setting of a function necessary for a sensor function in an attachment portion that aligns a lens unit with a mount portion.

### Solution to Problem

According to one aspect of a sensor module of the present disclosure, the sensor module includes a lens unit, a base portion on which a sensor for receiving light from the lens unit is installed, a mount portion installed on the base portion, and an attachment portion that aligns the mount portion with the lens unit.

The sensor module may further include at least any one of a first sliding portion that causes the mount portion to slidably support the attachment portion and a second sliding portion that causes the attachment portion to slidably support the lens unit, or include both of the first sliding portion and the second sliding portion.

In the sensor module, the attachment portion may include a diaphragm portion that reduces an amount of light received from the lens unit.

In the sensor module, the attachment portion may include an optical filter that allows light from the lens unit to pass through the optical filter.

In the sensor module, the attachment portion may include a filter portion integrally including an optical filter in a diaphragm portion that reduces an amount of light received from the lens unit.

In the sensor module, the mount portion may be provided with a dustproof filter that protects the sensor from dust.

In the sensor module, an opening diameter of the diaphragm portion may be larger than an image circle diameter of the lens unit, or substantially the same diameter or the same diameter as the image circle diameter.

According to one aspect of a manufacturing method for a sensor module of the present disclosure, the manufacturing method includes: forming a mount portion for mounting a lens unit on a base portion on which a sensor for receiving light from the lens unit is installed; forming an attachment portion for supporting the lens unit on the mount portion; and forming at least any one of a first sliding portion that causes the mount portion to slidably support the attachment portion and a second sliding portion that causes the attachment portion to slidably support the lens unit, or forming both of the first sliding portion and the second sliding portion.

The manufacturing method for a sensor module may further include forming a diaphragm portion that reduces an amount of light received from the lens unit in the attachment portion.

The manufacturing method for a sensor module may further include installing an optical filter that allows light from the lens unit to pass through the optical filter in the attachment portion.

According to one aspect of a sensor system of the present disclosure, in the manufacturing method for a sensor module, the sensor system includes the sensor module, wherein at least reflected light is received from a subject, and distance information is acquired using the reflected light.

### Advantageous Effects of Invention

According to the present disclosure, any of the following effects can be obtained.
(1) Since the lens unit and the mount portion are aligned by the attachment portion, it is possible to eliminate an alignment property for aligning the mount portion with the lens unit, and it is possible to increase the degree of freedom of the lens unit and the mount portion such as facilitating mounting of the lens units having different outer diameters.
(2) It is possible to increase the degree of freedom in design such as making it possible to make the mount portion common and mount different lens units.

### BRIEF DESCRIPTION OF DRAWINGS

FIG. 1 is an exploded perspective view illustrating a sensor module according to a first embodiment.

FIG. 2 is a partial cross-sectional view illustrating an alignment function of the sensor module.

FIG. 3 is a diagram illustrating alignment between a mount portion made common and a lens unit.

FIG. 4 is a partial cross-sectional view illustrating a sensor module according to a second embodiment.

FIG. 5 is a partial cross-sectional view illustrating a sensor module according to a third embodiment.

FIG. 6 is a block diagram illustrating a sensor system according to a fourth embodiment.

### MODE(S) FOR CARRYING OUT THE INVENTION

### First Embodiment

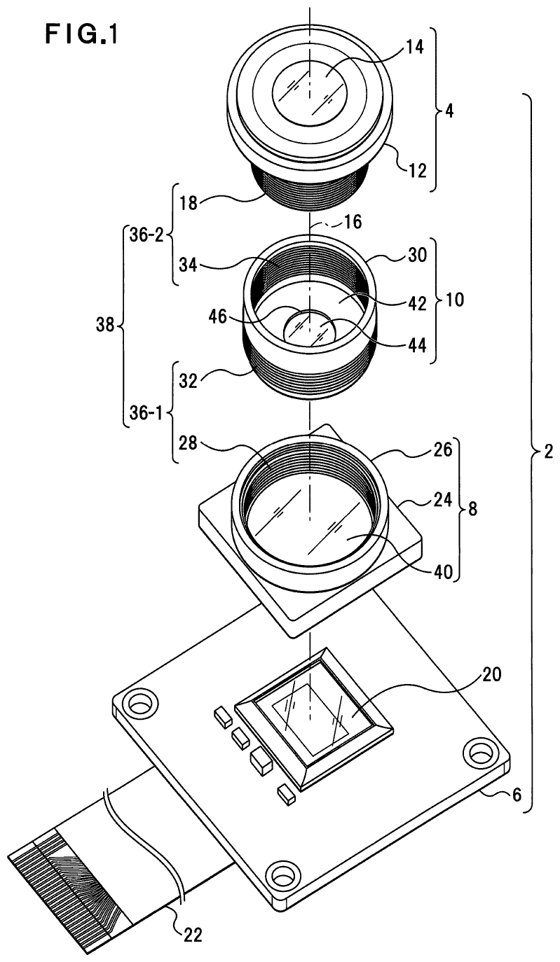

FIG. 1 illustrates a sensor module 2 according to a first embodiment. The configuration illustrated in FIG. 1 is an example, and the present disclosure is not limited to such a configuration.

The sensor module 2 is, for example, sensor means used to receive light, reflected light, or an image from a subject (not illustrated) and acquire distance information or image information. The sensor module 2 includes a lens unit 4, a base portion 6, a mount portion 8, and an attachment portion 10.

The lens unit 4 includes various lenses 14 such as an objective lens in a tube portion 12 having a cylindrical shape, and receives light, reflected light, or an image from the subject. A male screw portion 18 for sliding the lens unit 4 in the direction of an optical axis 16 is formed on the outer periphery of the tube portion 12.

The base portion 6 includes a sensor 20 such as an image sensor, operates in response to a control input (not illustrated), receives light through the lens unit 4, and generates a light receiving signal. A connector 22 for inputting a drive signal to the sensor 20 and extracting a sensor output is connected to the base portion 6.

The mount portion 8 is a member that is fixed to the base portion 6 for mounting the lens unit 4 and the like. The mount portion 8 has a housing function of surrounding the sensor 20 and blocking light other than light from the lens unit 4. The mount portion 8 includes a substrate portion 24, and the mount portion 8 is fixed to the base portion 6 by the substrate portion 24. A female screw portion 28 for sliding the attachment portion 10 in the direction of the optical axis 16 is formed in a tube portion 26 formed integrally with the substrate portion 24.

The attachment portion 10 is an alignment member that is installed between the lens unit 4 and the mount portion 8 and aligns the lens unit 4 with the mount portion 8. The attachment portion 10 has a light blocking function of blocking light from other than the lens unit 4. In a tube portion 30 included in the attachment portion 10, a male screw portion 32 that matches the female screw portion 28 of the mount portion 8 is formed on an outer peripheral portion, and a female screw portion 34 that matches the male screw portion 18 of the lens unit 4 is formed on an inner peripheral portion of the tube portion 30.

In this embodiment, a first sliding portion 36-1 is configured by the female screw portion 28 on the mount portion 8 side and the male screw portion 32 on the attachment portion 10 side in the mount portion 8 and the attachment portion 10, and a second sliding portion 36-2 is configured by the male screw portion 18 on the lens unit 4 side and the female screw portion 34 on the attachment portion 10 side in the lens unit 4 and the attachment portion 10. Therefore, in the sensor module 2, the lens unit 4 is slid in the direction of the optical axis 16 by using any one or both of the first sliding portion 36-1 and the second sliding portion 36-2, thereby constituting a focusing mechanism 38 for forming an image on a light receiving surface of the sensor 20 with the light received from the lens unit 4.

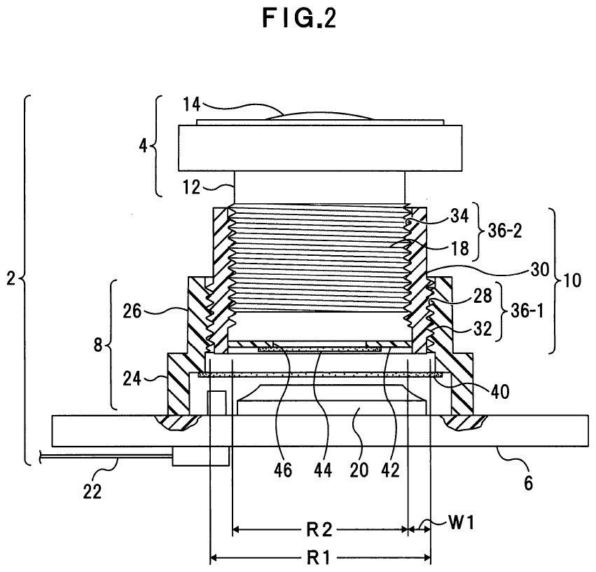

FIG. 2 illustrates a cross section of the sensor module 2 assembled. A dustproof filter 40 for protecting the sensor 20 from dust is installed in the mount portion 8.

A diaphragm portion 42 is installed in the attachment portion 10, and an optical filter 44 for setting an optical function according to an application is installed in the diaphragm portion 42. In this embodiment, the optical filter 44 is integrated with a back surface of the diaphragm portion 42, and an opening 46 of the diaphragm portion 42 is closed by the optical filter 44.

In FIG. 2, R1 is the diameter of the first sliding portion 36-1, R2 is the diameter of the second sliding portion 36-2, W1 is the thickness of the attachment portion 10, and the thickness W1 is expressed by Formula 1.

$$W 1 = ( R 1 - R 2 ) / 2 \geq Wx \qquad ( Formula 1 )$$

The thickness W1 of the attachment portion 10 is equal to or larger than a thickness Wx, and the thickness Wx is a thickness to the extent that the attachment portion 10 is slidably supported to the mount portion 8 by the first sliding portion 36-1 and the lens unit 4 is slidably supported to the attachment portion 10 by the second sliding portion 36-2.

In other words, a size relationship between the diameters R1 and R2 is R1>R2, and the diameter R1 needs to have a size that allows the attachment portion 10 including the second sliding portion 36-2 that slides the lens unit 4 to slide. That is, the thickness W1 needs to be equal to or larger than the thickness Wx at which the first sliding portion 36-1 and the second sliding portion 36-2 can be formed in the attachment portion 10.

<Alignment of Lens Unit 4 with Mount Portion 8 by Attachment Portion 10>

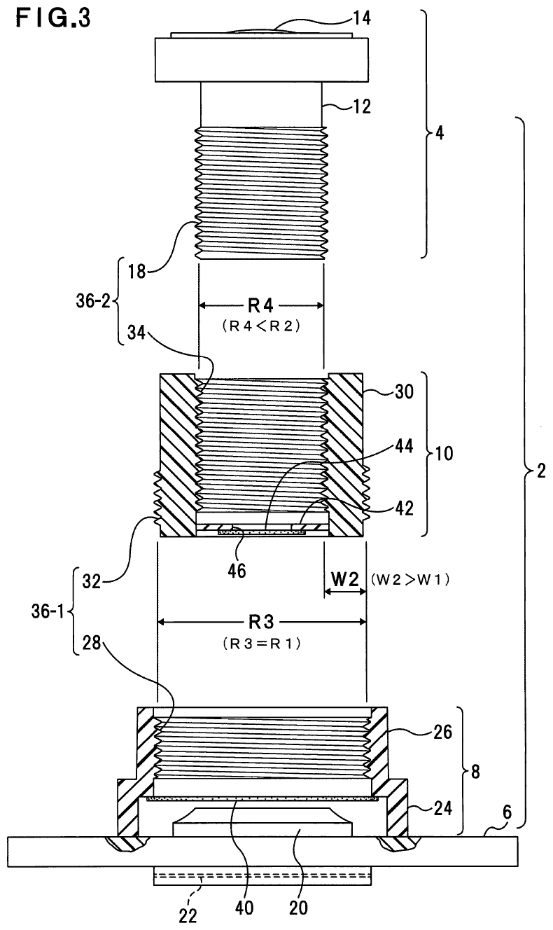

FIG. 3 illustrates alignment between the common mount portion 8 and the lens unit 4 having a different diameter. The lens unit 4 illustrated in FIG. 3 is smaller in diameter than the lens unit 4 illustrated in FIG. 2, and the mount portion 8 is common to the mount portion 8 (FIG. 2) described above. Therefore, the attachment portion 10 aligns the lens unit 4 with the mount portion 8.

In this case, when the mount portion 8 is made common to the mount portion 8 illustrated in FIG. 2, a diameter R3 of the first sliding portion 36-1 is the same diameter as the diameter R1 (R3=R1). The attachment portion 10 can be slidably supported with respect to the mount portion 8. On the other hand, when a diameter R4 of the second sliding portion 36-2 is set to a size that is aligned with the lens unit 4, the lens unit 4 can be slidably supported to the attachment portion 10.

In order to obtain such a sliding relationship, when the diameter of the first sliding portion 36-1 is R3 (=R1) and the diameter of the second sliding portion 36-2 is R4, a thickness W2 of the attachment portion 10 can be expressed by Formula 2 similarly to Formula 1.

$$W 2 = ( R 3 - R 4 ) / 2 = ( R 1 - R 4 ) / 2 \qquad ( Formula 2 )$$

The thickness W2 of the attachment portion 10 is also equal to or larger than the thickness Wx to the extent that the attachment portion 10 is slidably supported to the mount portion 8 by the first sliding portion 36-1 and the lens unit 4 is slidably supported to the attachment portion 10 by the second sliding portion 36-2.

Then, from Formulas 1 and 2, a thickness difference ΔW between the thicknesses W1 and W2 of the attachment portion 10 can be expressed by Formula 3.

$$Δ W = W 2 - W 1 = ( R 2 - R 4 ) / 2 \qquad ( Formula 3 )$$

Therefore, when the mount portion 8 is made common and the diameter R3 of the first sliding portion 36-1 is made common to the diameter R1 (FIG. 2) (R3=R1), the thickness W2 of the attachment portion 10 may be adjusted to realize the diameter R4 of the second sliding portion 36-2.

### <Manufacturing Method for Sensor Module 2>

The manufacturing of the sensor module 2 according to the embodiment includes a selecting step or a forming step of the lens unit 4, a forming step of the mount portion 8, a mounting step of the sensor 20 and the mount portion 8, a forming step of the attachment portion 10, and an assembling step of the sensor module 2 using the lens unit 4, the mount portion 8, and the attachment portion 10.

### A) Selecting Step or Forming Step of Lens Unit 4

When the sensor 20 necessary for the sensor module 2 is selected, the lens unit 4 corresponding to the sensor 20 is selected. Instead of the selection of the lens unit 4, the lens unit 4 having an optical characteristic corresponding to an application or the sensor 20 may be formed. The tube portion 12 of the lens unit 4 may be formed of metal such as aluminum or a hard synthetic resin such as polyethylene terephthalate (PET). The male screw portion 18 of the second sliding portion 36-2 is formed on an outer peripheral portion of the lens unit 4.

### B) Forming Step of Mount Portion 8

When the lens unit 4 is selected or formed, the mount portion 8 for adapting to the lens unit 4 is formed. The mount portion 8 surrounds the sensor 20 mounted on the base portion 6 to form a dark room space and includes a mount housing having a size at which the mount housing can be aligned with the first sliding portion 36-1 that slidably supports the attachment portion 10. The mount portion 8 may be formed of metal such as aluminum or a hard synthetic resin such as PET. The female screw portion 28 of the first sliding portion 36-1 is formed on an inner peripheral portion of the mount portion 8.

The diameter R1 of the first sliding portion 36-1 of the mount portion 8 needs to be matched with the outer diameter of the attachment portion 10 that slidably supports the lens unit 4. Then, the dustproof filter 40 is integrally attached to the mount portion 8 to achieve dustproofing of the light receiving surface of the sensor 20 mounted on the base portion 6.

### C) Mounting Step of Sensor 20 and Mount Portion 8

After the base portion 6 is formed in advance from a printed circuit board or the like and the sensor 20 is mounted on the base portion 6, the mount portion 8 is mounted on the base portion 6 so as to cover the sensor 20. With this mounting, the sensor 20 is surrounded by the mount portion 8, and the dark room is achieved. At the same time, the sensor 20 is made dustproof by the dustproof filter 40 in the mount portion 8.

### D) Forming Step of Attachment Portion 10

The attachment portion 10, which is aligned with the lens unit 4 on the inner peripheral portion side and aligned with the mount portion 8 on the outer peripheral portion side, is formed by molding or cutting. A metal material such as aluminum or a hard synthetic resin material such as PET may be used for the attachment portion 10. In the attachment portion 10, the male screw portion 32 of the first sliding portion 36-1 is formed on the outer peripheral portion side, and the female screw portion 34 of the second sliding portion 36-2 is formed on the inner peripheral portion side.

Therefore, as described above, the thickness W1 of the attachment portion 10 is set to be equal to or larger than the thickness Wx to the extent that the attachment portion 10 is slidably supported to the mount portion 8 by the first sliding portion 36-1 and the lens unit 4 is slidably supported to the attachment portion 10 by the second sliding portion 36-2.

The diaphragm portion 42 is installed in the attachment portion 10, the optical filter 44 is installed in the attachment portion 10 and on a lower surface side of the diaphragm portion 42, and the opening 46 is closed by the optical filter 44. For example, a flange portion may be formed on an inner peripheral portion of the attachment portion 10 by cutting or molding of the attachment portion 10, and the opening 46 having a circular shape may be formed in the flange portion to form the diaphragm portion 42.

The diaphragm portion 42 may be formed as a separate member from the attachment portion 10, and a filter unit in which the optical filter 44 is integrally installed on the diaphragm portion 42 formed in advance may be used. Then, desired optical characteristics designated by an application are set in the optical filter 44. Therefore, the attachment portion 10 constitutes an optical component having the optical characteristics suitable for the application.

### E) Assembling Step of Sensor Module 2

After the sensor 20 is mounted at a predetermined position of the base portion 6, the mount portion 8, the attachment portion 10, and the lens unit 4 are mounted. The attachment portion 10 and the lens unit 4 may be integrated in advance and mounted as a single component on the mount portion 8, or the attachment portion 10 may be mounted on the mount portion 8, the attachment portion 10 may be integrated with the mount portion 8, and the lens unit 4 may be mounted on the attachment portion 10.

<Relationship between Image Circle Diameter of Lens Unit 4 and Opening 46 of Diaphragm Portion 42>

When an image circle diameter of the lens unit 4 is ic and an opening diameter of the diaphragm portion 42 is r, a size relationship between the image circle diameter ic and the opening diameter r is as follows.

The opening diameter r may be any of the followings:
a) Diameter larger than image circle diameter ic: r>ic;
b) Substantially the same diameter as image circle diameter ic: r≈ic; and
c) The same diameter as image circle diameter ic: r=ic.

That is, it is sufficient when the size relationship between the opening diameter r of the diaphragm portion 42 and the image circle diameter ic is r>ic, but it is preferable when the opening diameter r of the diaphragm portion 42 and the image circle diameter ic are substantially the same diameter (that is, r≈ic), or it is more preferable when they are the same diameter (that is, r=ic).

### Effects of First Embodiment

According to the first embodiment, any of the following effects can be obtained.
(1) An alignment property between the mount portion 8 and the lens unit 4 can be eliminated, and the degree of freedom of the mount portion 8 and the lens unit 4 can be increased.
   (2) Even when the mount portion 8 is made common, an arbitrary lens unit 4 can be aligned with the mount portion 8 by the attachment portion 10.
   (3) Even when the mount portion 8 and the lens unit 4 are separately manufactured, the mount portion 8 and the lens unit 4 can be precisely aligned via the attachment portion 10.
   (4) A desired optical filter 44 can be set in the attachment portion 10 according to an application to be executed, the lens unit 4 can be released from restriction by the application, and the degree of freedom in selecting the lens unit 4 can be increased.
   (5) When the inner diameter of the attachment portion 10 is adjusted to the outer diameter of the lens unit 4, the lens unit 4 can be aligned with the mount portion 8 without changing the mount portion 8 even when the lens unit 4 has a different outer diameter.
   (6) Since the optical filter 44 is disposed in the attachment portion 10, the optical filter 44 can be easily changed with the attachment portion 10 as compared with a conventional configuration in which the optical filter 44 is incorporated in the mount portion 8.
   (7) The opening diameter r of the diaphragm portion 42 disposed in the attachment portion 10 and the image circle diameter ic of the lens unit 4 can be changed together with the attachment portion 10.
   (8) Since the attachment portion 10 includes the diaphragm portion 42 as an optical function portion, noise light entering through the lens unit 4 and unnecessary light outside an optical path can be suppressed by the attachment portion 10. As a result, since reflection and scattering (stray light) of unnecessary light can be suppressed, it is possible to realize condensing of necessary light and a sharp image.

### Second Embodiment

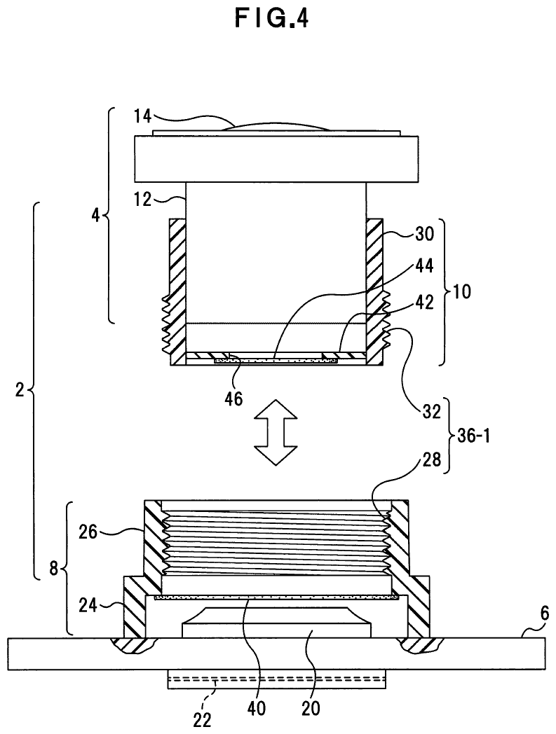

FIG. 4 illustrates a sensor module 2 according to a second embodiment. In FIG. 4, the same parts as those in FIGS. 1 and 2 are denoted by the same reference numerals.

The sensor module 2 of this embodiment has a configuration in which an attachment portion 10 and a mount portion 8 are made slidable only by a first sliding portion 36-1, and the attachment portion 10 is fixed to a lens unit 4 to be unified, and a second sliding portion 36-2 is omitted.

### Effects of Second Embodiment

According to the second embodiment, any of the following effects can be obtained.
(1) The lens unit 4 can be slid to focus only by the first sliding portion 36-1 without the second sliding portion 36-2.
(2) As for a sliding range, it is possible to realize a sliding width equivalent to that of the first embodiment only by the first sliding portion 36-1 between the mount portion 8 and the attachment portion 10.

### Third Embodiment

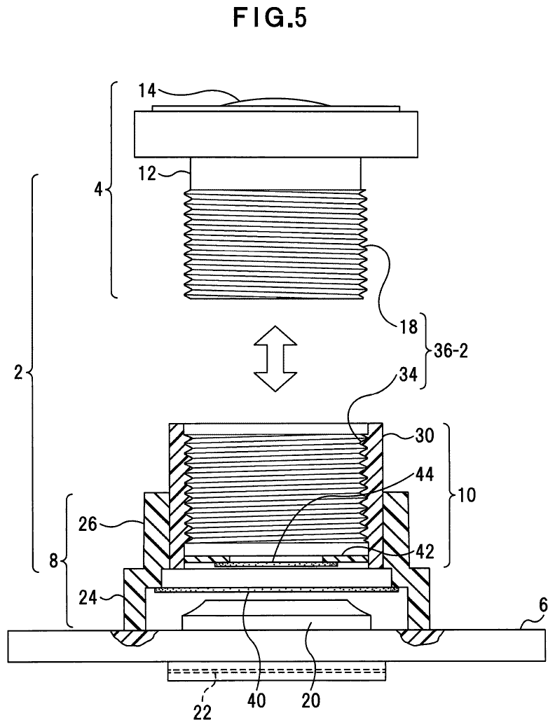

FIG. 5 illustrates a sensor module 2 according to a third embodiment. In FIG. 5, the same parts as those in FIGS. 1, 2, and 3 are denoted by the same reference numerals.

The sensor module 2 of this embodiment has a configuration in which a lens unit 4 and an attachment portion 10 are made slidable only by a second sliding portion 36-2, a mount portion 8 and the attachment portion 10 are fixed to be unified, and a first sliding portion 36-1 is omitted.

### Effects of Third Embodiment

According to the third embodiment, any of the following effects can be obtained.
(1) The lens unit 4 can be slid only by the second sliding portion 36-2 without the first sliding portion 36-1.
(2) As for a sliding range, as in the second embodiment, it is possible to realize a sliding width equivalent to that of the first embodiment or the second embodiment only by the second sliding portion 36-2 between the lens unit 4 and the attachment portion 10.

### Fourth Embodiment

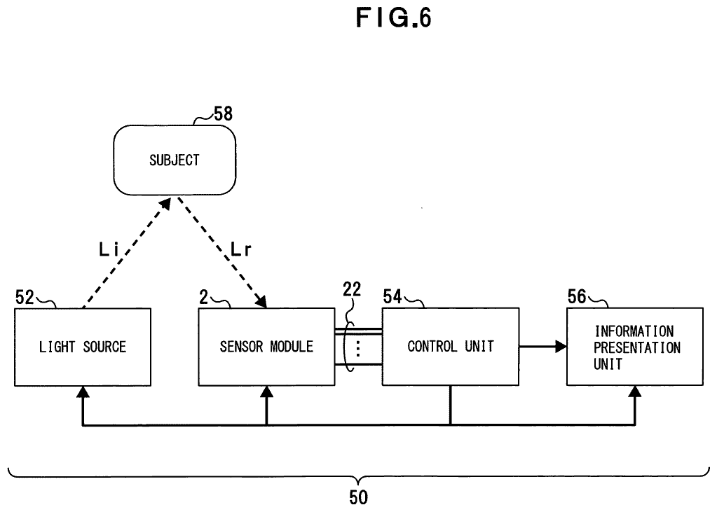

FIG. 6 illustrates a sensor system 50 according to a fourth embodiment. In FIG. 6, the same parts as those in FIG. 1 are denoted by the same reference numerals. The sensor system 50 is, for example, a system that acquires distance information using the sensor module 2 described above.

The sensor system 50 illustrated in FIG. 6 includes the sensor module 2, a light source 52, a control unit 54, and an information presentation unit 56.

The light source 52 is controlled by the control unit 54, and irradiates, for example, a subject 58 with laser light Li.

The control unit 54 is configured by a computer, performs light reception control of reflected light Lr from the subject 58 by the sensor module 2 together with light emission control of the light source 52, measures a time from a time point of emission of the laser light Li to a time point of reception of the reflected light Lr, acquires distance information of the subject 58, and generates presentation information.

The information presentation unit 56 includes, for example, a liquid crystal display (LCD) indicator, and presents image information including, for example, grayscale information indicating the distance information of the subject 58 under presentation control of the control unit 54. For example, contrast information representing a subject image in which a distant position is dark and a near position is bright is an example of the image information.

### Effects of Fourth Embodiment

According to the fourth embodiment, any of the following effects can be obtained.
(1) The sensor system 50 such as a distance meter can be configured using the sensor module 2.
   (2) The distance to the subject 58 can be easily recognized using the sensor system 50.

### Other Embodiments

Hereinafter, other embodiments will be described.
(1) In the above embodiment, the first sliding portion 36-1 and the second sliding portion 36-2 use rotational sliding with a male screw and a female screw, but another sliding mechanism such as a sliding mechanism by friction may be used.
   (2) In the above embodiment, the single attachment portion 10 is provided, but two or more attachment portions 10 may be provided.
   (3) In the above embodiment, the attachment portion 10 including the diaphragm portion 42 and the optical filter 44 is used, but any of an attachment member not including both of the diaphragm portion 42 and the optical filter 44 and an attachment member including any one of the diaphragm portion 42 and the optical filter 44 may be used for the attachment portion 10. That is, even when such an attachment member is used for the attachment portion 10, the lens unit 4 and the mount portion 8 can be aligned.
   (4) In the above embodiment, the sensor system 50 that acquires distance information using the sensor module 2 has been exemplified, but image information may be acquired to present an image.

As described above, the most preferred embodiment and the like of the present disclosure have been described. The technology of the present disclosure is not limited to the above description. Various modifications and changes can be made by those skilled in the art based on the gist of the invention described in the claims or disclosed in the description. It goes without saying that such modifications and changes are included in the scope of the present invention.

### INDUSTRIAL APPLICABILITY

According to the sensor module, the manufacturing method therefor, or the sensor system of the present disclosure, since the mount portion and the lens unit are aligned by the attachment portion, there is convenience such as an increase in the degree of freedom for alignment of the mount portion with the lens unit, which is extremely beneficial.

### REFERENCE SIGNS LIST

2 sensor module
4 lens unit
6 base portion
8 mount portion
10 attachment portion
12 tube portion
14 lens
16 optical axis
18, 32 male screw portion
20 sensor
22 connector
24 substrate portion
26 tube portion
28, 34 female screw portion
30 tube portion
36-1 first sliding portion
36-2 second sliding portion
38 focusing mechanism
40 dustproof filter
42 diaphragm portion
44 optical filter
46 opening
50 sensor system
52 light source
54 control unit
56 information presentation unit
58 subject

1. A sensor module comprising:
a lens unit;
a base portion on which a sensor for receiving light from the lens unit is installed;
a mount portion installed on the base portion; and
an attachment portion that aligns the mount portion with the lens unit.

2. The sensor module according to claim 1, further comprising at least any one of a first sliding portion that causes the mount portion to slidably support the attachment portion and a second sliding portion that causes the attachment portion to slidably support the lens unit, or comprising both of the first sliding portion and the second sliding portion.

3. The sensor module according to claim 1, wherein
the attachment portion includes a diaphragm portion that reduces an amount of light received from the lens unit.

4. The sensor module according to claim 1, wherein
the attachment portion includes an optical filter that allows light from the lens unit to pass through the optical filter.

5. The sensor module according to claim 1, wherein
the attachment portion includes a filter portion integrally including an optical filter in a diaphragm portion that reduces an amount of light received from the lens unit.

6. The sensor module according to claim 1, wherein
the mount portion is provided with a dustproof filter that protects the sensor from dust.

7. The sensor module according to claim 3, wherein
an opening diameter of the diaphragm portion is larger than an image circle diameter of the lens unit, or substantially the same diameter or the same diameter as the image circle diameter.

8. A manufacturing method for a sensor module, the manufacturing method comprising:
forming a mount portion for mounting a lens unit on a base portion on which a sensor for receiving light from the lens unit is installed;
forming an attachment portion for supporting the lens unit on the mount portion; and
forming at least any one of a first sliding portion that causes the mount portion to slidably support the attachment portion and a second sliding portion that causes the attachment portion to slidably support the lens unit, or forming both of the first sliding portion and the second sliding portion.

9. The manufacturing method for a sensor module according to claim 8, the manufacturing method further comprising
forming a diaphragm portion that reduces an amount of light received from the lens unit in the attachment portion.

10. The manufacturing method for a sensor module according to claim 8, the manufacturing method further comprising
installing an optical filter that allows light from the lens unit to pass through the optical filter in the attachment portion.

11. A sensor system comprising
the sensor module according to claim 1, wherein at least reflected light is received from a subject, and distance information is acquired using the reflected light.

12. The sensor module according to claim 2, wherein
the attachment portion includes a diaphragm portion that reduces an amount of light received from the lens unit.

13. The sensor module according to claim 2, wherein
the attachment portion includes an optical filter that allows light from the lens unit to pass through the optical filter.

14. The sensor module according to claim 12, wherein
the attachment portion includes an optical filter that allows light from the lens unit to pass through the optical filter.

15. The sensor module according to claim 2, wherein
the attachment portion includes a filter portion integrally including an optical filter in a diaphragm portion that reduces an amount of light received from the lens unit.

16. The sensor module according to claim 2, wherein
the mount portion is provided with a dustproof filter that protects the sensor from dust.

17. The manufacturing method for a sensor module according to claim 9, the manufacturing method further comprising
installing an optical filter that allows light from the lens unit to pass through the optical filter in the attachment portion.
